(19) United States
(12) Patent Application Publication
(10) Pub. No.: US 2014/0021421 A1
(43) Pub. Date: Jan. 23, 2014

(54) TENSIONING DEVICE

(71) Applicant: Sverre Rye Torben, Langevag (NO)

(72) Inventor: Sverre Rye Torben, Langevag (NO)

(73) Assignee: ROLLS-ROYCE MARINE AS, Alesund (NO)

(21) Appl. No.: 14/008,748

(22) PCT Filed: Apr. 3, 2012
(86) PCT No.: PCT/EP12/01474

§ 371 Date: Oct. 11, 2013

(30) Foreign Application Priority Data
Apr. 4, 2011 (NO) 20110517

(51) Int. Cl. B66D 1/40

(52) U.S. Cl. CPC B66D 1/40
USPC 254/277

(57) ABSTRACT

A tensioning device (7) for tensioning of a rope or cable (5) to be spooled onto or off a winch drum (4), the tension device (7) comprising wheels (10, 20, 30, 40), drums and/or belts(10, 20, 30, 40), characterised in that the wheels, drums and/or belts (10, 20, 30, 40) are arranged to be displaced from an disengaged position where the rope or cable (5) is running freely through the tensioning device (7), and an engaged position where the rope or cable (5) rests against said wheels, drums and/or belts (10, 20, 30, 40) that are provided with braking means (13) to withhold the rope or cable (5) to provide a tension, is described. A hoisting device comprising a tensioning device (7) is also described.

### TECHNICAL FIELD

The present invention relates to subsea lifting operations to overcome challenges with spooling tension when using light weight material for the lifting rope. More specifically, the invention relates to a method and device for reducing the rope bend fatigue compared to alternative solutions and provides easy integration in lifting structures such as cranes, A-frames, moonpool towers etc.

The invention can also be beneficial for other type of ropes and cables (steel wire, umbilicals, etc) and other type of operations than subsea lifting operations (mining, subsea intervention, pipe lay operations/A&R operations (Abandonment and Recovery operations (A&R)), well intervention, etc).

### BACKGROUND ART

The core challenge when recovering an empty hook with a light weight lifting rope using a normal drum winch is that the rope will be spooled onto the drum at low tension. When a subsequent deployment (or retrieval from more shallow water depths) of a heavy payload is done, there is a risk that rope at high tension will squeeze into the loosely spooled on rope layers beneath creating risk of damage to the rope and abortion of the operation.

To overcome this problem, traction units like the applicant's own U.S. Pat. No. 6,182,915, has been developed. The device of US '915 comprises of a number of traction sheave that can be installed between a payload and a storage drum to provide low variations of spooling tension for a wide range of loads. Some of the benefits of this solution are:
Handling of flexible ropes/cables with low slippage between tension device and rope/cable during tensioning/de-tensioning process.
Ability to handle splices and objects in the rope.
De-tensioning of rope before spooled onto a winch drum to a tension level acceptable for the rope (e.g. vs. Creep or crushing of fibers) and the drum.
No twisting of the rope (assures zero fleeting angle).

This solution is also characterized by some features that are not optimum in some applications:
As the rope is always running around the traction sheaves even when not strictly needed which means that more rope bend cycles are accumulated on the rope than necessary during:
   Deployment operations.
   Recover operations.
   Active Heave Compensation (AHC) operations.
Large diameter of the traction sheaves (large D:d ratio) is recommended to reduce heat buildup and wear of fibre rope in AHC operations.

Arrangement of this solution in a crane structure, A-frame, moonpool tower or other structures used for bringing a load to/from the deck and out of/into the water is quite spacious partly driven by the size of the traction sheaves given by the D:d recommendations.

U.S. Pat. No. 7,389,973 relates to a tensioning device for a rope comprising a plurality of rollers arranged in two groups, where the rope to be tensioned is arranged in a zigzag way from one roller in one of the groups, to a roller in the other group, back to a roller in the first group and so on through the device. The two groups of rollers may be moved actively or passively to adjust the distance between the groups of rollers, to take in slack in the rope to keep it tensioned. There is, however, no indication that the device according to US '973 may be used to keep a constant tension at one side of the device, with varying tension of the rope at the other of the device or to provide a tension difference over the device. Accordingly, the device described in US '973 would have no, or limited value, for applications where a minimum tension is required onto a drum even if the lifting tension is varying or where a tension increase in the rope is needed before spooling the rope onto a drum.

Modern ropes have a density close to the density of water. The tension in a rope when pulling in a rope without any load may, however, vary due to the slight density difference between water and the rope, and due to dynamic forces. Additionally, the rope has to be spooled onto a winch at a minimum tension to avoid the above mentioned problems that will arise when deploying a heavy load if the rope is too loosely spooled onto the winch.

An object of the present invention is to provide a method and device making it possible to ascertain that a certain minimum spooling tension, or optionally a constant spooling tension, is maintained when spooling a rope onto a drum even if the lifting tension, or operational tension to a lifting device varies or is too low, and at the same time elude the problems mentioned in the prior art.

### SUMMARY OF INVENTION

According to a first aspect, the present invention relates to a tensioning device for tensioning of a rope or cable to be spooled onto or off a winch drum, the tension device comprising wheels, drums and/or belts arranged so that the rope or cable can be arranged to rest sequential against the wheels, drums or belts, wherein that the wheels, drums and/or belts are arranged to be displaced from an disengaged position where the rope or cable is running freely through the tensioning device, and an engaged position where the rope or cable rests against said wheels, drums and/or belts that are provided with rotational control means to withhold or to pull in the rope or cable to provide a tension. By means of the claimed device making it possible to shift the tensioning device, according to the need, from a disengaged position where the rope of cable is allowed to pass freely without being passed over sheaves, drums, wheels or the like, to an engaged position, where full tensioning force is available when needed. Shifting between an engaged and disengaged position according to the need, reduces the number of unnecessary bending cycles applied to the rope or cable, and the wear and tear thereof, substantially.

According to an embodiment, the device comprises a plurality of drums or wheels that are arranged on a rotary arranged sheave support or arm, where the sheave or arm support can be rotated from an disengaged position where wheels or drums do not interact with the rope or cable, to a position where the wheels or drums are tensioning interaction with the rope or cable.

According to a specific embodiment, the wheels or drums are arranged in pairs, with one pair on each drum support or arm arranged so that the rope or cable is allowed to pass between the wheels or drums of the pairs of wheels or drums in the disengaged position, and where the rope or cable is caused to run in a zigzag manner over the wheels or drums in the engaged position.

According to an alternative embodiment, the wheels or drums are displaceably arranged so that they can be displaced from a disengaged position where the rope or cable can pass between a pair of wheels or drums, and an engaged position where pairs of wheels or drums are forced against the rope or cable, one from each side thereof to provide tension.

According to one embodiment, belts are arranged to be displaced between a disengaged position where the rope or cable can pass between a pair of belts, and an engaged position where pairs of belts are forced against the rope or cable, one from each side thereof to provide tension.

According to one embodiment, the rotational control means are mechanical brakes. Mechanical brakes are the simplest rotational control means that can be best compromise between cost and effect for certain solutions.

According to another embodiment, the rotational control means are electrical or hydraulic motors. Electrical or hydraulic motors are more complex than mechanical brakes, but add benefits to the flexibility of the tensioning device. Electrical or hydraulic motors are easy to control, and the braking energy may be led away and used for other purposes, whereas the braking energy is converted to heat energy in mechanical brakes.

According to a second aspect the invention relates to a hoisting device, comprising a winch drum for a rope or cable, one or more drums for redirecting the rope or cable from the winch drum to a load and a tensioning device comprising wheels, drums and/or belts, for tensioning of the rope or cable according to the need therefore, characterised in the wheels, drums or belts are arranged to be displaced from an disengaged position where the rope or cable is running freely through the tensioning device, and an engaged position where the rope or cable (5) rests against said wheels, drums and/or belts that are provided with braking means to withhold the rope or cable to provide a tension.

According to one embodiment, the hoisting device is a crane.

According to one embodiment, the tensioning unit is arranged on the arm of the crane.

According to one embodiment, the tensioning unit is arranged so that it can be displaced in a direction substantially perpendicular to the length axis of the rope or cable.

According to a different embodiment, the hoisting device is a moonpool tower.

According to still another embodiment, the hoisting device is an A-frame.

### BRIEF DESCRIPTION OF DRAWINGS

FIG. 1 illustrates a crane with tensioning units installed on crane boom and the winch as a back-pack,

FIG. 2 illustrates the crane shown in FIG. 1 seen for a different angle,

FIG. 3a illustrates a tensioning unit based on traction sheaves in a disengaged position,

FIG. 3b illustrates the tensioning unit of FIG. 3a, in engaged position,

FIG. 4a illustrates a an alternative tensioning unit based on traction belts in a disengaged position,

FIG. 4b illustrates the tensioning unit of FIG. 4a, in engaged position,

FIG. 5a illustrates a an alternative tensioning unit based on wheel pairs in a disengaged position,

FIG. 5b illustrates the tensioning unit of FIG. 5a, in engaged position,

FIG. 6 illustrates an disengaged position of an alternative tension unit based on a plurality of single wheels with linear actuation for engagement/disengagement,

FIG. 7 illustrates a crane with tensioning units and winch installed under deck of the vessel,

FIG. 8 illustrates a tower structure with tensioning units installed between the winch and tower top,

FIG. 9 is a side view of an alternative embodiment, and

FIG. 10 is a top view of the embodiment of FIG. 9, where FIG. 10a) shows the tensioning unit in a dis-engaged position, whereas FIG. 10b) shows the tensioning unit in an engaged position, the tensioning device is also assuring the spooling function in this embodiment by moving the tensioning device back and forward relative to the winch drum.

### DETAILED DESCRIPTION OF THE INVENTION

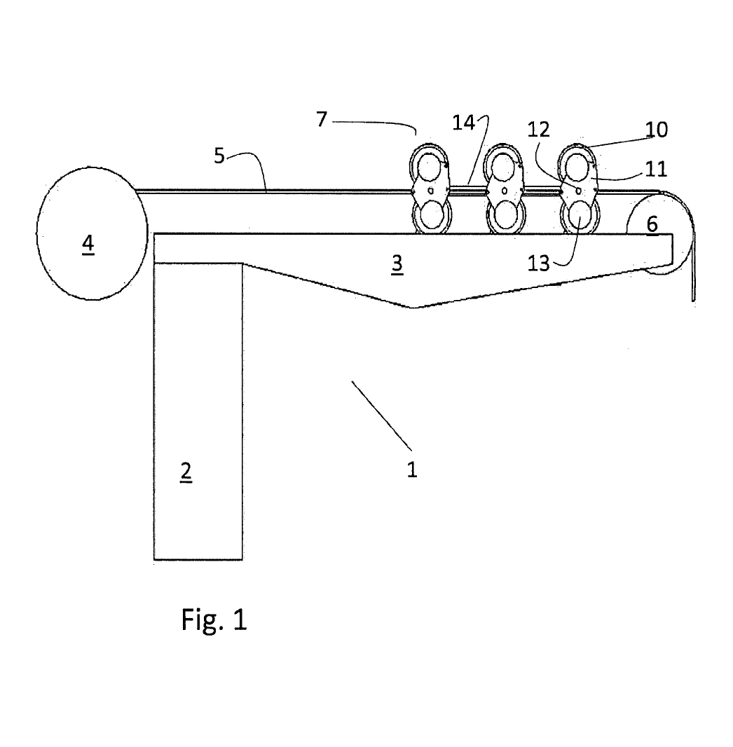

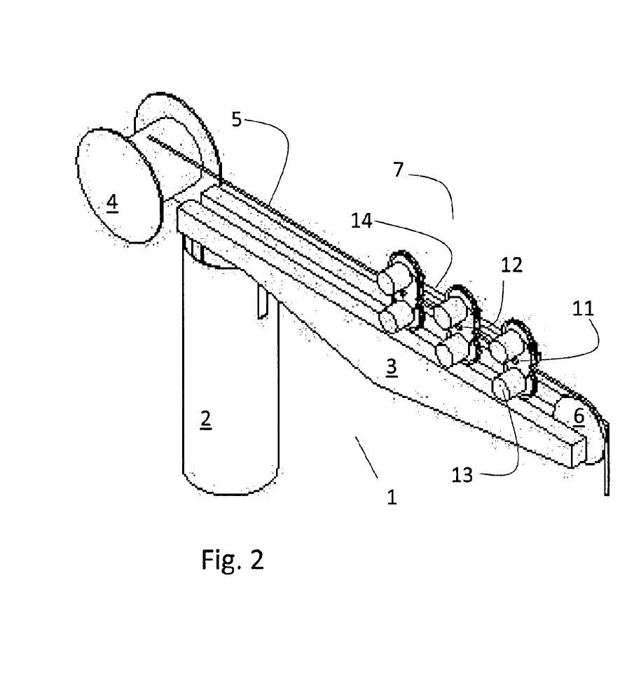

FIGS. 1 and 2 illustrate the base case of the innovation, where a crane 1, comprising a base 2 and a crane arm 3, is provided with a winch drum 4 for a rope 5 running from the winch 4 over a sheave 6 to a not shown load. A tensioning unit 7 is arranged in the path of the rope 5 between the winch 4 and the sheave 6. The rope 5 is running freely through the tensioning unit 7 illustrated in FIGS. 1 and 2, where the tensioning unit is in its dis-engaged position.

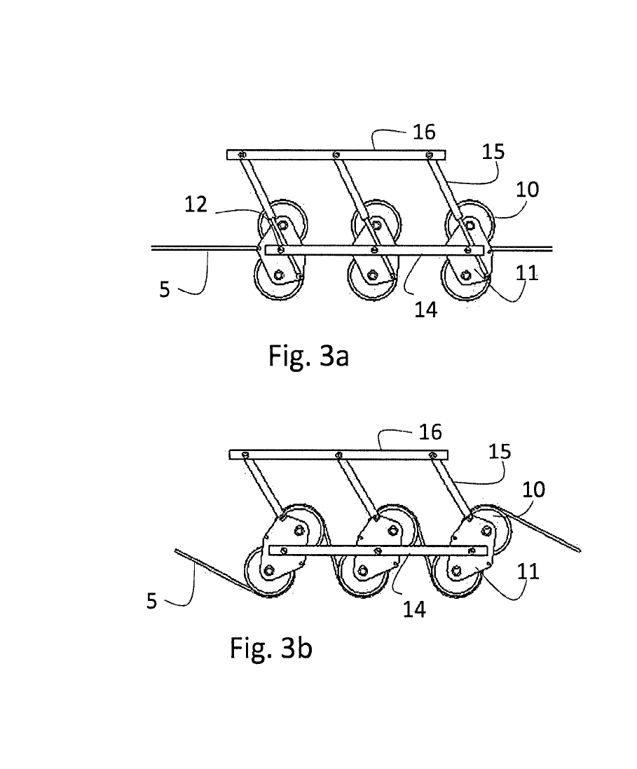

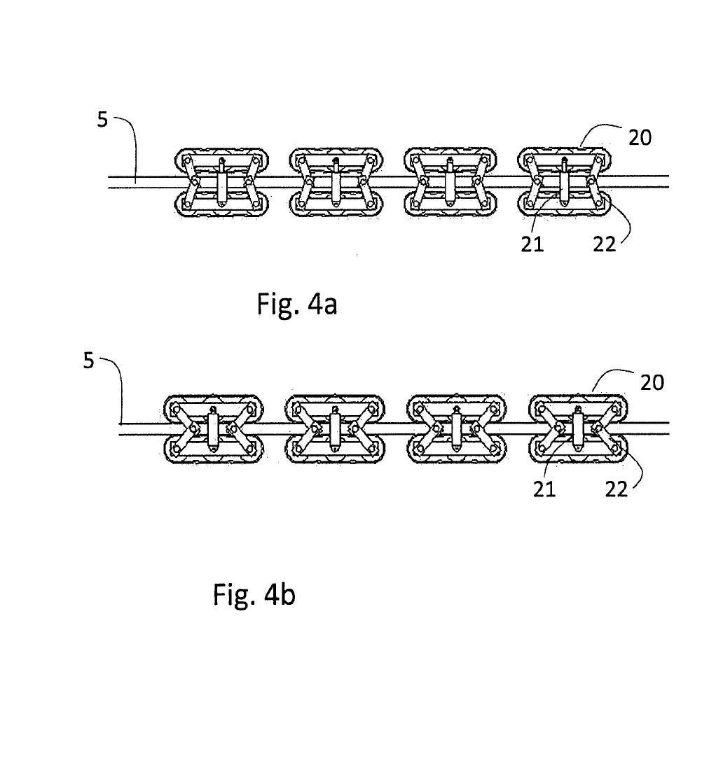

The tensioning device 7 illustrated in FIGS. 1 and 2, is the unit shown in FIGS. 3a and b, Any other tensioning unit providing the same functionality, such as the embodiments described with reference to FIGS. 4a, 4b, 5a, 5b, 6, may, however substitute for the unit of FIGS. 3a, 3b.

FIGS. 3a and 3b illustrate the function of the tensioning unit 7 illustrated in FIGS. 1 and 2. It comprises several of traction sheaves 10, each being arranged on a rotary arranged traction sheave support 11, and sheaves having an axis of rotation 12 being substantially perpendicular to the traction sheave support 11 (or traction sheave 10). The traction sheave support 11 is rotary arranged about an axis of rotation that is substantially parallel with the axis of rotation of the traction sheaves. The axis of rotation of the traction sheaves 10, and the axis of rotation of the sheave support carrying the of traction sheaves, are parallel and define a common plane.

The sheave support 11 is rotary connected to a support structure 14, which is illustrated as a bar. The support structure 14 has, however, to be firmly fixed to a solid structure, such as the crane arm 3 or other supportive structure dependent on the actual arrangement. When the tensioning device is arranged at a crane arm, the support structure is fixed to the crane arm by not shown structures. An actuator 15 is connected to the tension sheave support 11 and an actuator support 16, so that the sheave support may be rotated by means of the actuator 15. The actuator support may be the crane arm itself, or a separate structure fixed to the crane arm.

FIG. 3a illustrates tensioning device in a first, or disengaged position, where the rope 5 passes freely between the traction sheaves. The tensioning unit will be in this position when there is no need for tensioning of the rope 5. When the tensioning device is needed, the actuator is activated to rotate the sheave support 11, as illustrated in FIG. 3b. The rope which passed freely between the traction sheaves in the disengaged position, will then be forced into a zigzag pattern, resting at the circumferential surface of the traction sheaves 10. The tensioning device may comprise one or more pairs of traction sheaves or braking sheaves depending on the demand for the construction, such as a crane, in question. The skilled man will also understand that in a tensioning device comprising a plurality of pairs of traction sheaves, the pairs may be activated independently, dependent on the actual demand, to give sufficient tensioning or braking force to the rope.

Each traction sheave is preferably connected to a separate rotational control unit 13. The rotational control units may be units that can be used to control the rotation the wheels, drums or endless belts of the tensioning device. Candidate rotational control means are mechanical brakes set to a predetermined breaking torque, adjustable mechanical brakes, or hydraulic or electrical motors used as brakes, as well known by the skilled man. The rotational control units 13 are preferably individually controllable. By being able to control the rotational control units individually, the units may be adjusted to allow individual speed and torque of the sheaves to compensate for rope elongation or diameter variations as the rope and associated objects and splices are passing through the tensioning device.

Electrical or hydraulic motors used as the rotational control units 13, have certain advantages over mechanical brakes. Electrical or hydraulic motors are easier to control than mechanical brakes. Additionally, when using electrical motors as brakes, the motors are used as generators generating electrical power that can be used for other purposes, e.g. operation of the rope drum or for charging of batteries. Correspondingly, when using an hydraulic motor as a brake, the motor functions as a pump, generating high pressure hydraulic oil, that may be used to running other winches, such as e.g. the rope drum, or for charging of accumulators. The generation of electrical power or high pressure hydraulic oil additionally reduces the requirement for cooling, as a substantial part of the braking energy is recovered as electrical or hydraulic energy, respectively.

Finally, using an electrical or hydraulic motor as the rotational control unit, also makes it possible to use the present device as a traction winch participating in the pulling in of a rope under tension, such as for lifting a heavy load. Under these circumstances the rotational control units will be used as motors for operating the sheaves.

The skilled person will understand that the description above relating to the rotational control units, also relates to all the other embodiments illustrated and described herein.

FIGS. 4a and 4b illustrate an alternative tensioning device, comprising a plurality of traction belts 20, being arranged in pairs facing each other. In a pair of traction belts, the belts are displaceably arranged, so that the belts may be displaced from a disengaged position where the distance between the belts allows the rope 5 to pass freely between the belts in a pair, and engaged position where the belts are forced against the rope 5. One or more actuators, 21, preferably assisted by guiding rods 22, is/are provided for each pair of to control the distance between the belts, and to control the force exerted onto the rope. As for the device described with reference to FIGS. 1 to 3, the same kind of preferably individually controllable rotational control devices are arranged to the belts.

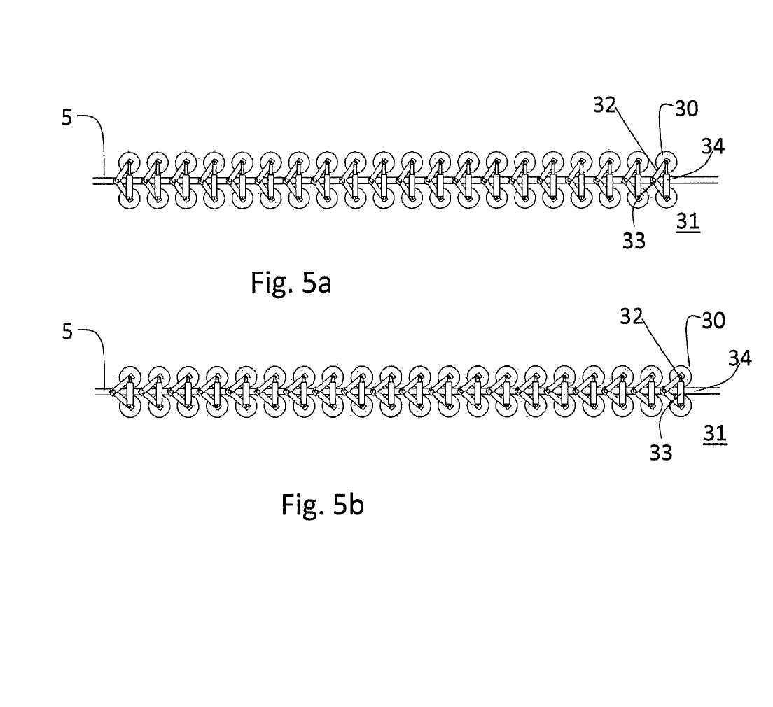

FIGS. 5a and 5b illustrate yet an alternative tensioning device, comprising a plurality of wheels 30 arranged in pairs. The wheels 30 are connected to a main structure 31 by means of an arm 32, rotary arranged on the main structure. The arm of each pair of wheels 30 are rotary arranged about one common axis of rotation 33. An actuator 34 is connected to the free end of each arm 32 of a pair, to displace the wheels in a pair from a disengaged position where the rope is allowed to pass freely between the wheels, and a position where the wheels of a pair are forced against each other and the rope between the wheels. Braking devices of the above described type are provided for all wheels to control the tensioning. As illustrated in FIG. 5a and b, the pairs of wheels are arranged so that a rope is allowed to run in a substantially straight line through the tensioning device. The skilled person will understand that even though FIGS. 5a and 5b illustrates a device where the wheels are connected to a main structure by means of a rotary arranged arm, the wheels may alternatively be arranged in linear tracks and be moved linearly relatively to each other.

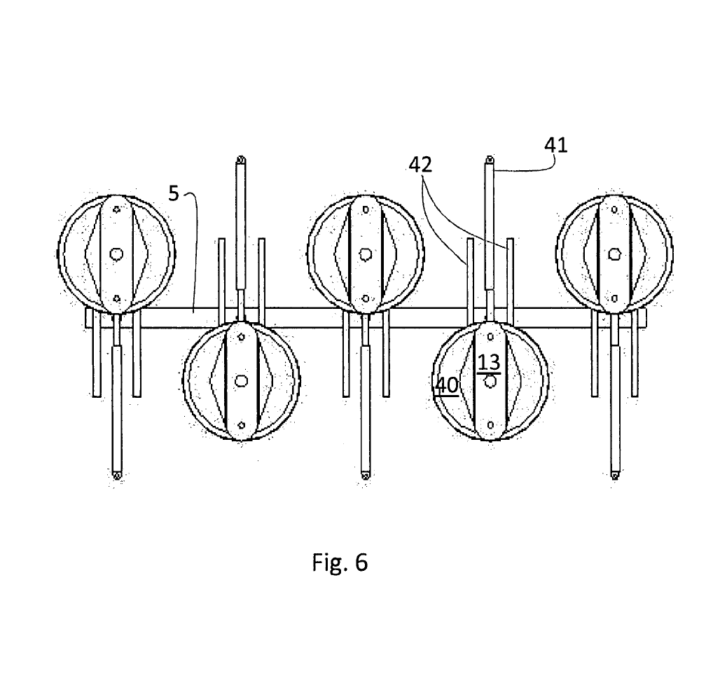

FIG. 6 illustrate an alternative embodiment comprising a plurality of single traction sheaves 40 that can be linearly displaced from the disengaged position as shown in FIG. 6 by means of actuators 41, into an engaged position where the rope/cable is caused to follow a zigzag pattern as in FIG. 3b. Tracks 42 arranged perpendicular to the direction of the rope/cable in the disengaged position of the device, may be provided for supporting the wheels.

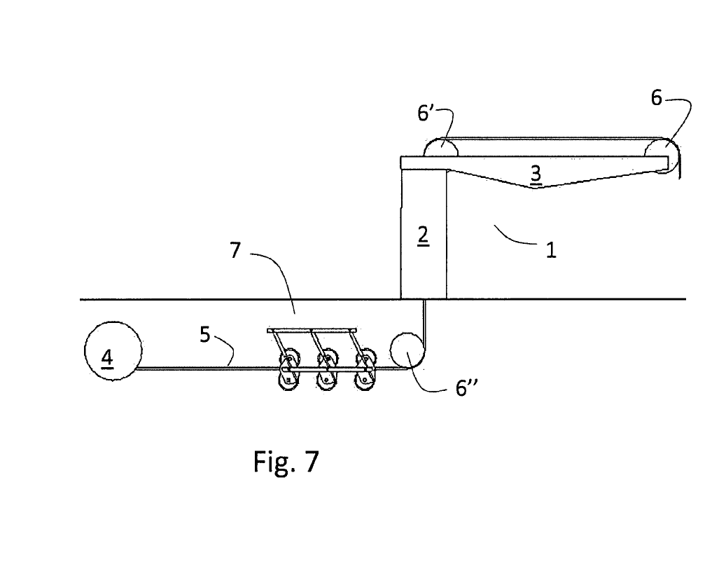

FIG. 7 illustrates an alternative embodiment of the present invention where the winch drum 4 and tensioning device 7 are arranged below the deck of the vessel. The rope is guided over sheaves 6′, 6″ from the crane to the tensioning device 7. The skilled man will understand that even if the described tensioning device is the device of FIGS. 1 to 3, any equivalent tensioning device may be used.

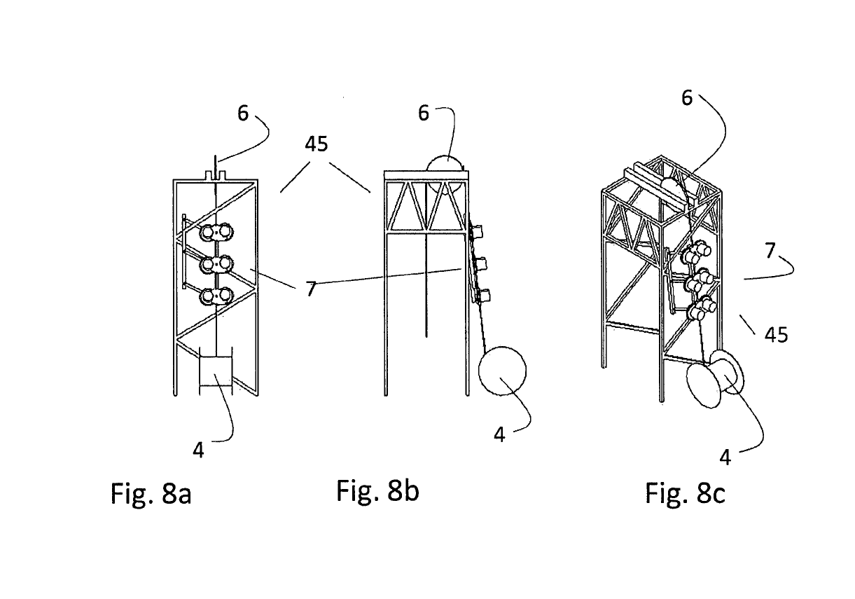

FIGS. 1, 2 and 6 illustrate the use of a tensioning device that may be engaged and disengaged, in connection with a crane, this kind of tensioning devices may be useful also in lifting operations and lifting equipment not including a crane. FIG. 8a), b) and c) illustrate, seen from different angles, an alternative use of the present tensioning unit 7, arranged at a moonpool tower 45 for lifting operation through a not shown moonpool. The skilled man will also understand that the present tensioning device may be applicable in several other situations, such as e.g. A-frames and the like, used for retrieval or deployment in subsea operations.

The skilled man will also understand that a spooling device for spooling rope onto the winch (if the distance from the tensioning units to the winch is too short compared to the drum width too assure self spooling), may be included, without leaving the scope of the invention. Also included in the device may be guiding wheels or guiding devices for guiding the rope into and out from the tensioning device.

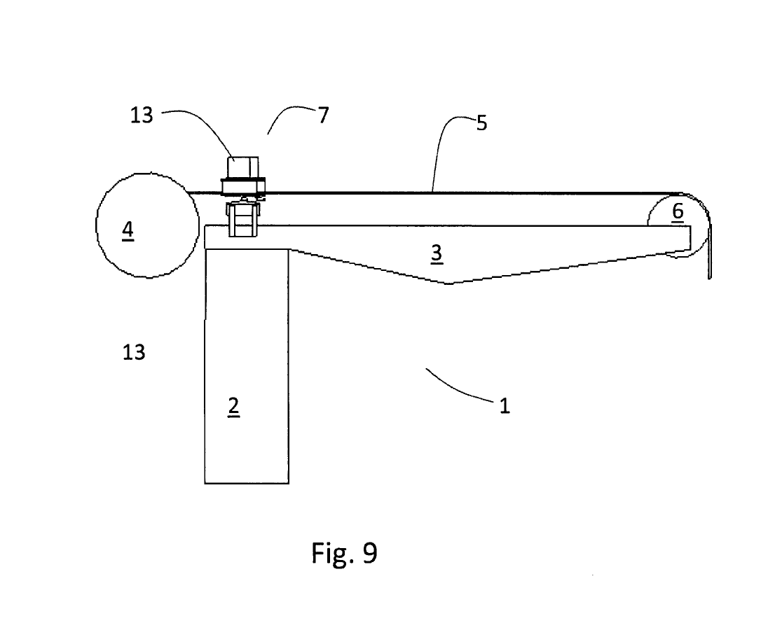

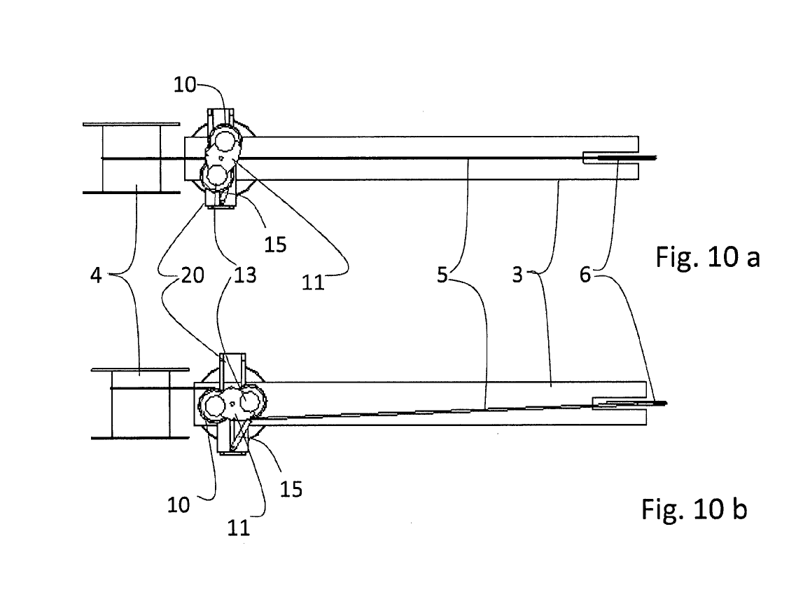

FIGS. 9 and 10a) and b) illustrate an embodiment of the present tensioning device where the tensioning unit 7 comprises two sheaves 10 corresponding to a pair of sheaves in the device of FIGS. 1, 2, 3. The elements of this embodiment that are the same in this embodiment and the prior described embodiments are given the same reference numerals and any description that does not include functions or feature being different in this embodiment, is not further discussed here.

The tensioning unit 7 is slideably arranged at a spooling track 20 so that it may be moved across the length axis of the crane arm 3 to adjust the point of attack for the rope 5 onto the winch drum 4 to act as a spooling device. The device illustrated in FIGS. 9 and 10 will thus act both as a tensioning unit and as a spooling unit. The sideways movement of the tensioning unit at the spooling track 20 is controlled means of a not shown actuator, to give a controlled spooling at the winch drum 4. FIG. 10a illustrates the tensioning device 7 in a disengaged position where the rope 5 may pass freely through the device, whereas FIG. 10b illustrates the tensioning device 7 in an engaged position. The skilled man will understand that the combined tensioning unit and spooling unit described with reference to FIGS. 9, 10a, 10b, may be used as a spooling device without activating the tensioning function of the tensioning unit 7. The skilled person will also understand that the spooling track has to be substantially parallel to the axis of rotation of the drum.

The skilled person will understand that the tensioning unit 7 in a device with a combined tensioning unit and spooling unit, may comprise more than one pair of sheaves 10. One or more additional pair of sheaves 10 may be slideably arranged as the illustrated pair, or one or more additional pair of sheaves may be arranged close to the sheave 6 at the free end of the crane arm 3.

The skilled person will understand that any of the illustrated tensioning units may additionally comprise guiding wheels or sheaves to guide the rope 5 into and/or out from the tensioning device 7.

The embodiments described above of the present tensioning device all describe versions where all wheels or sheaves are moved from a disengaged position to an engaged position according to the needs. The skilled person will also understand that one or more of the wheels of sheaves are stationary and that other wheels or sheaves are relocated to bring the rope or cable into interaction with the tensioning device as described herein.

The present tensioning units are characterized by the following features:
The tensioning units can be engaged or disengaged. This is typically achieved by hydraulic cylinders, but motors or other type of actuators could also be used.
When engaged, the rope will interact with the tensioning units to change the tension in the rope.
When disengaged, the rope can pass through the tensioning units without interaction.

The skilled man will understand from the description that the tensioning units have as a minimum a braking function capable of increasing the tension in the rope as rope is being recovered to the winch drum (typically used when recovering the empty hook or a light payload). Additionally, the tensioning units may also have the following additional tensioning functions:
A pulling function making it capable of de-tensioning the rope before it is stored on the winch drum in case of recovery of heavy load.
A braking function making it possible to reduce the rope pull on the winch drum during deployment of heavy load.
A pulling function making it possible to maintain a high tension on the winch when deploying a light load.

If the tensioning unit consists of several braking or pulling elements, each element or subgroup of elements can operate individually to accommodate tensioning/de-tensioning of ropes and passage of splices and objects with low slippage between the rope and the braking or pulling element even for flexible ropes.

The braking functions may be obtained from hydraulic or electric drive units or mechanical brakes.

The pulling functions, if included, can be obtained from hydraulic or electric drive units.

An example of a typical installation operation is given below: Initial situation:
The rope is ready and spooled onto the winch drum at sufficient tension for the installation operation.
Tension units are disengaged
Hook is attached to the module to be lifted, while still on deck
The module is lifted of the deck and through the splash zone.
The module is deployed to approx. 50 m above the seabed using the winch.
The AHC (on the winch) is activated.
Landing operation of the module at the sea bed is performed in AHC mode.
The rope is unloaded and the hook disconnected from the module.
The tensioning units are engaged
The empty hook and the rope are recovered by spooling the rope onto the winch at wanted tension. The tension level is controlled by tensioning units.
The tensioning units are disengaged when the hook is recovered to deck.

1. A tensioning device for tensioning of a rope or cable to be spooled onto or off a winch drum, the tensioning tension device comprising:
wheels or drums arranged so that the rope or cable can be arranged to rest sequential against the wheels, drums or belts;
wherein the wheels or drums are arranged to be displaced from a disengaged position where the rope or cable runs freely through the tensioning device, and an engaged position where the rope or cable rests against the wheels or drums;
wherein the wheels or drums are provided with rotational control means to withhold or to pull in the rope or cable to provide a tension; and
wherein the tensioning device comprises a plurality of drums or wheels that are arranged on a rotary arranged sheave support or arm, where the rotary arranged sheave support or arm can be rotated from a disengaged position where wheels or drums do not interact with the rope or cable to a position where the wheels or drums are in tensioning interaction with the rope or cable.

2. The tensioning device of claim 1, where wherein:
the wheels or drums are arranged in pairs, with one pair on each rotary arranged sheave support or arm arranged so that the rope or cable is allowed to pass between the wheels or drums of the pairs of wheels or drums in the disengaged position; and
wherein the rope or cable is caused to run in a zigzag manner over the wheels or drums in the engaged position.

3. The tensioning device of claim 1, where the wheels or drums are displaceably arranged so that the wheels or drums can be displaced from the disengaged position, and the engaged position.

4. (canceled)

5. The tensioning device of claim 1, wherein the rotational control means are mechanical brakes.

6. The tensioning device of claim 1, wherein the rotational control means are electrical or hydraulic motors.

7. The tensioning device according to claim 1, wherein the tensioning device is displaceably arranged, in a direction substantially parallel to an axis of rotation of the winch drum to guide the rope or cable onto or off the winch drum.

8. (canceled)

9. The hoisting device of claim 14, wherein the hoisting device is a crane.

10. The hoisting device of claim 9, wherein the tensioning device is arranged on the arm of the crane.

11. The hoisting device of claim 9, wherein the tensioning device is arranged so that the tensioning device can be displaced in a direction substantially perpendicular to a length axis of the rope or cable.

12. The hoisting device of claim 9, wherein the hoisting device is a moonpool tower.

13. The hoisting device of claim 9 wherein the hoisting device is an A-frame.

14. A hoisting device, comprising:
a tensioning device for tensioning of a rope or cable to be spooled onto or off a winch drum, the tensioning device comprising:
wheels or drums, arranged so that the rope or cable can be arranged to rest sequentially against the wheels or drums;
wherein the wheels or drums are arranged to be displaced from a disengaged position where the rope or cable runs freely through the tensioning device, and an engaged position where the rope or cable rests against the wheels or drums;
rotational control means to withhold or to pull in the rope or cable to provide a tension; and
wherein the hoisting device comprises a plurality of drums or wheels that are arranged on a rotary arranged sheave support or arm, where the rotary arranged sheave support or arm can be rotated from a disengaged position where the wheels or drums do not interact with the rope or cable, to a position where the wheels or drums are in tensioning interaction with the rope or cable.
